(19) United States
(12) Patent Application Publication
(10) Pub. No.: US 2026/0288548 A1
(43) Pub. Date: Sep. 24, 2026

(54) DYNAMICALLY ADJUSTING PRIORITY IN MESSAGE QUEUE

(71) Applicant: International Business Machines Corporation, Armonk, NY (US)

(72) Inventors: Xin Xin Dong, Beijing (CN); Peng Hui Jiang, Beijing (CN); Jun Su, Beijing (CN); Mai Zeng, Beijing (CN); Jing Zhang, Poughkeepsie, NY (US)

(21) Appl. No.: 19/083,567

(22) Filed: Mar. 19, 2025

(51) Int. Cl. G06F 9/54; G06F 9/48

(52) U.S. Cl. CPC G06F 9/546; G06F 9/4881; G06F 2209/548

(57) ABSTRACT

A computer-implemented method to dynamically adjust prioritization in a message system. A message manager may receive, by a message system and from a producer, a plurality of messages. A message manager may determine, based on a set of prioritization rules; a priority score for each message of the plurality of messages, wherein the set of prioritization rules is based on feedback from a set of messages previously processed by the message system. A message manager may send, selectively and based on the priority, each message to a consumer for each message to be processed.

### BACKGROUND

The present disclosure relates to message queues, and in particular, to dynamically adjusting message priority based on real-time conditions.

In a message queue system, messages are typically stored in a queue and processed by one or more consumers. Each message may have a certain priority level that determines the order in which it gets processed.

### SUMMARY

In some aspects, the techniques described herein relate to a computer-implemented method including: receiving, by a message system and from a producer, a plurality of messages; determining, based on a set of prioritization rules; a priority score for each message of the plurality of messages, wherein the set of prioritization rules is based on feedback from a set of messages previously processed by the message system; and sending, selectively and based on the priority, each message to a consumer for each message to be processed.

In some aspects, the techniques described herein relate to a system including: a processor; and a computer readable storage medium communicatively coupled to the processor and storing program instructions which, when executed by the processor, are configured to cause the processor to: receive, by a message system and from a producer, a plurality of messages; determine, based on a set of prioritization rules; a priority score for each message of the plurality of messages, wherein the set of prioritization rules is based on feedback from a set of messages previously processed by the message system; and send, selectively and based on the priority, each message to a consumer for each message to be processed.

In some aspects, the techniques described herein relate to a computer program product, the computer program product including a computer readable storage medium having program instructions embodied therewith, the program instructions executable by a processing unit to cause the processing unit to: receive, by a message system and from a producer, a plurality of messages; determine, based on a set of prioritization rules; a priority score for each message of the plurality of messages, wherein the set of prioritization rules is based on feedback from a set of messages previously processed by the message system; and send, selectively and based on the priority, each message to a consumer for each message to be processed.

The present Summary is not intended to illustrate each aspect of, every implementation of, and/or every embodiment of the present disclosure.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 is a block diagram of a computing environment suitable for dynamically adjusting message priority in a message system, in accordance with some embodiments of the present disclosure.

FIG. 2 is a block diagram of a computing environment suitable for operation of a message manager in accordance with some embodiments of the present disclosure.

FIG. 3 is a message system showing data and message flow through the message system, in accordance with some embodiments of the present disclosure.

FIG. 4 is a flow chart of an example method to dynamically adjusting message priority in a message system, in accordance with some embodiments of the present disclosure.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as dynamically adjusting message priority in a message system of block 195. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

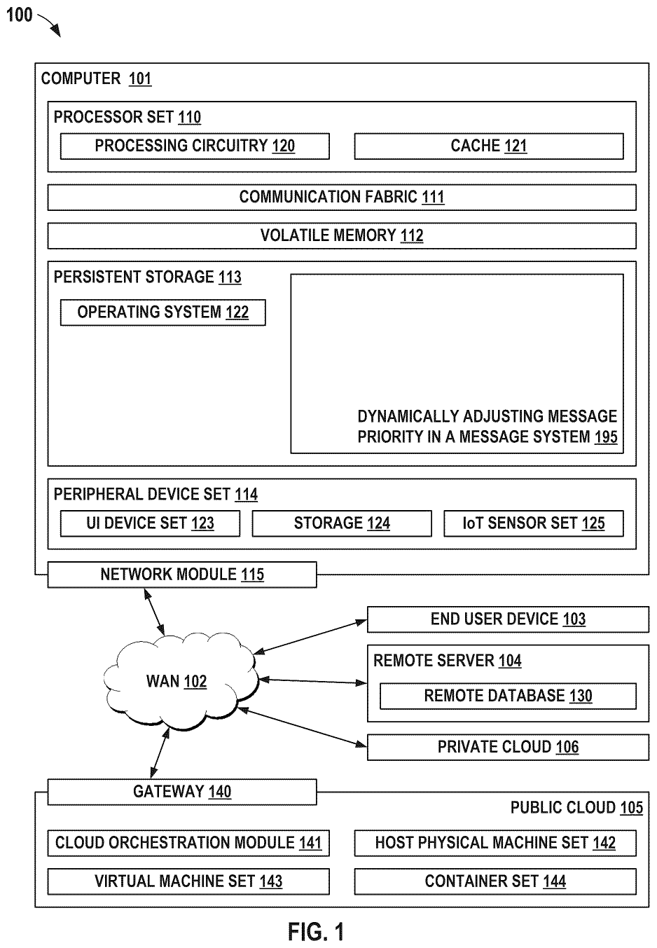

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 195 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The present disclosure relates to message queues, and in particular, to dynamically adjusting message priority based on real-time conditions.

In a message queue system, messages are typically stored in a queue and processed by one or more consumers. Each message may have a certain priority level that determines the order in which it gets processed. Some embodiments of message queue processing systems (or message queue systems) offer prioritization. Prioritization determines which messages in the queue are processed in what order. Various factors can be used to prioritize or prioritize various messages/queues. However, existing systems may have rigid prioritization rules that lack adaptability and necessitate manual intervention, hindering system efficiency.

Embodiments of present disclosure can dynamically adjust message prioritization in a message queue system.

In some embodiments, the message queue system includes a message manager (or a message queue manager). The message manager can identify a priority of messages being generated by one or more producers. The messages can be configured to be consumed by one or more consumers.

In some embodiments, the message manager directs each message of the plurality of messages to one or more message queues. Each of the queues (or partitions) can have an assigned priority. The assigned queue can be based on a prioritization or ranking of the message. The prioritization can be based on a set of rules and/or conditions. For example, a policy can provide prioritization and/or routing rules for various incoming messages. In some embodiments, the message manager generates a priority score for each message. The priority score determines which level of queue the message will be assigned. There can be any number of queues for each message priority level. In some embodiments, each message priority level is associated with a score range and/or one or more predetermined rules.

In some embodiments, the message manager can adjust the prioritization of the messages. The adjustment can be based on feedback received from the consumers. The downstream feedback can cause the message routing manager to alter the priority of a message and/or the queue to which the message is assigned. This dynamic adjustment based on the downstream feedback can increase the efficiency of the overall system by increasing optimizing resource utilization and increasing responsiveness based on changes in a system load. In some embodiments, the adjusting is based on updated the priority score. The updated priority score can be adjusted based on a weighting of a factor and a value of a factor determined based on the feedback.

The dynamic adjusting of priority ranking of messages increases the responsiveness of a message system. It can ensure that the highest priority messages are rapidly acted upon. The prompt action can prevent cascading failures. Because, in a static system, if one queue gets overloaded, then the message system lacks the ability to react to load changes. The high priority message may be caught in a bottleneck or other similar unwanted scenario. Embodiments of the present disclosure also allows for efficient resource allocation. By processing critical alerts with higher priority, the system optimizes resource allocation, directing resources such as maintenance crews or emergency response teams to the most pressing issues first. This efficient allocation of resources maximizes operational efficiency and reduces response times, ultimately saving costs and mitigating risks. For example, if the message system is processing issues/outages related to the power grid, prioritizing critical alerts enhances the safety and reliability of the power grid by ensuring timely detection and resolution of potential issues. By addressing critical alerts promptly, the system reduces the likelihood of major disruptions, improves system resilience, and enhances overall grid performance.

The aforementioned advantages are example advantages, and embodiments exist that can contain all, some, or none of the aforementioned advantages while remaining within the spirit and scope of the present disclosure.

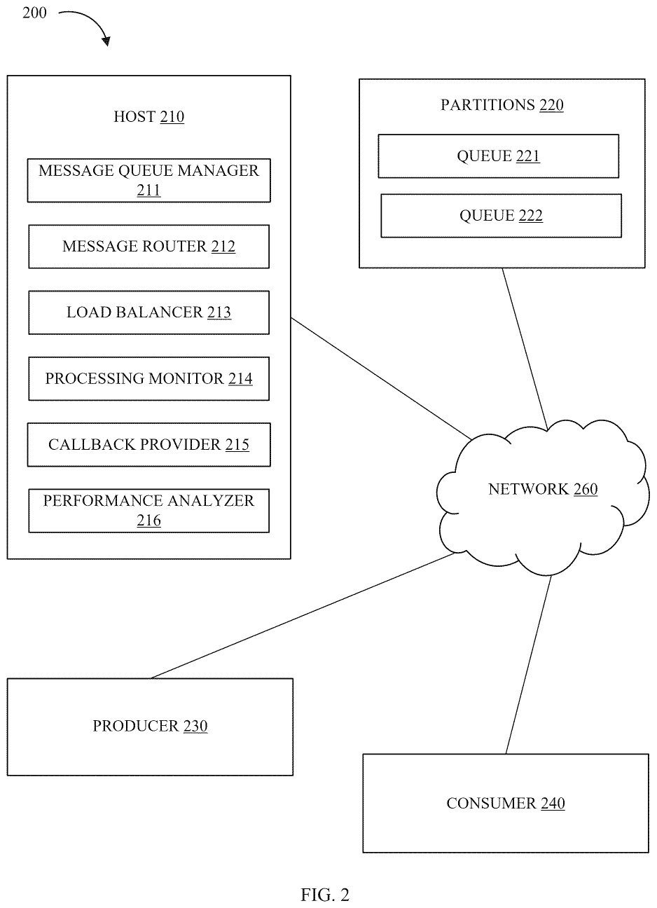

Referring now to various embodiments of the disclosure in more detail, FIG. 2 is a representation of a computing environment 200, that is capable of running a horn manager in accordance with one or more embodiments of the present disclosure. Many modifications to the depicted environment may be made by those skilled in the art without departing from the scope of the disclosure.

Computing environment 200 includes host 210, partitions 220, producer 230, consumer 240, and network 260. Network 260 can be, for example, a telecommunications network, a local area network (LAN), a wide area network (WAN), such as the Internet, or a combination of the three, and can include wired, wireless, or fiber optic connections. Network 260 may include one or more wired and/or wireless networks that are capable of receiving and transmitting data, voice, and/or video signals, including multimedia signals that include voice, data, and video information. In general, network 260 may be any combination of connections and protocols that will support communications between and among includes host 210, partitions 220, producer 230, consumer 240, and other computing devices (not shown) within computing environment 200. In some embodiments, each of includes host 210, partitions 220, producer 230, consumer 240, and other devices not shown may include one or more a computer system, such as computer 101 of FIG. 1.

Host 210 can be a standalone computing device, a management server, a web server, a mobile computing device, or any other electronic device or computing system capable of receiving, sending, and processing data. In other embodiments, host 210 can represent a server computing system utilizing multiple computers as a server system, such as in a cloud computing environment (e.g., public cloud 105 or private cloud 106). In some embodiments, host 210 includes message manager 211, message router 212, load balancer 213, processing monitor 214, callback provider 215, performance analyzer 216, and partitions 220. In some embodiments, host 210, and/or any number of the subcomponents of host 210 can be separated into any number of computing devices in any combination.

Message manager 211 can be any combination of hardware and/or software configured to manage the receipt and/or processing of messages in a message queue system. In some embodiments, message manager 211 dynamically updates message priority in a message queue system. Message manager 211 receives messages from one or more message producers (e.g., producer 230). In some embodiments, message manager 211 assigns the received messages to partition 220 In some embodiments, message manager 211 receives one or more messages from producer 230, assigns the messages to a queue in partitions 220, sends the messages to consumer 240, while monitoring the processing and/or build up of messages in the partitions 220. In some embodiments, message manager 211 dynamically adjust the assignment the messages to the various queues and/or consumer 240 to increase the efficiency of the system as a whole and/or prevent bottlenecks and other processing issues.

In some embodiments, message manager 211 includes one or more of message router 212, load balancer 213, processing monitor 214, callback provider 215, performance analyzer 216, partitions 220, queue 221, queue 222, producer 230, and/or consumer 240 in any combination. However, message router 212, load balancer 213, processing monitor 214, callback provider 215, performance analyzer 216, partitions 220, queue 221, queue 222, producer 230, and consumer 240 are shown separately for discussion purposes.

Message router 212 can be any combination of hardware and/or software configured to assign/send received messages to partition 220. In some embodiments, message router 212 routes messages based on a predefined message routing plan and/or dynamic message priorities. The predefined message routing plan can include instructions to determine and/or assign a priority/ranking for a received message. In some embodiments, the determining the message priority includes calculating an adjusted priority. The adjusted priority can be an initial priority added to an adjustment variable. For example, the adjustment can be expressed by the equation

$$Adjusted Priority = Initial Priority + {\sum }_{k = 0}^{n} Feedback {Weight}_{k} * Feedback {Value}_{k} ,$$

Where n is the number of feedback factors considered In some embodiments, message router 212 applies the initial or the adjust priority to score each message as it is received.

Load balancer 213 can be any combination of hardware and/or software configured to distribute messages to consumer 240. In some embodiments, load balancer 213 distributes the messages from the partition 220 and/or various queues to one or more consumer 240. The distributed can be configured to provide a relative consistent workload to each consumer 240. The workload can be number of messages, processing time, energy consumption and/or other similar factors. In some embodiments, load balancer 213 dynamically adjust workload distributions to prevent overloading an individual consumer 240. The efficient routing can minimize or reduce processing delays. In some embodiments, load balancer 213 routes the messages based on a priority of the message.

Processing monitor 214 can be any combination of hardware and/or software configured to monitor workloads and/or processing of consumer 240. In some embodiments, processing monitor 214 monitors performance metrics of consumer 240. The performance metrics can include response times, processing rates, workload distribution and other efficiency metrics. In some embodiments, processing monitor 214 identifies anomalies and/or patterns on consumer 240. The anomalies/patterns can include message processing delays, load imbalance, efficiency issues, and/or other similar issues. In some embodiments, processing monitor 214 generates reports and/or alerts based on the monitoring. The reports/alerts can be sent to message manager 211 and/or load balancer 213 to adjust message prioritization and/or message routing to consumer 240. In some embodiments, processing monitor 214 sends data to callback provider 215.

Callback provider 215 can be any combination of hardware and/or software configured to analyze all monitored data and/or recommend/generate changes to the message processing system. In some embodiments, callback provider 215 receives analyzed data from processing monitor 214. In some embodiments, callback provider can generate changes to the routing plan of load balancer 213 and/or the message prioritization rules utilized by message router 212.

Performance analyzer 216 can be any combination of hardware and/or software configured to analyze performance of the message processing system. In some embodiments, performance analyzer 216 can determine if the system is out of balance. In some embodiments, the analysis identifies anomalies and/or patterns in the distribution and/or processing of messages. For example, if one of consumer 240 is overloaded and/or underloaded. Additionally, performance analyzer 216 can determine if any particular partition/queue and/or any priority is too large. If one queue has a large or small number of messages waiting to be processed, that can indicate the a priority is out of balance. The analysis can identify system performance, message processing times, throughput, and/or resource utilization. In some embodiments, the analyzing can recommend changes to improve the performance of the overall system. The changes can include changes in the distribution of messages to keep load balanced and/or in the assigning the messages to the queues. In some embodiments, performance analyzer 216 can recommend changes to the priority scores to change the priority of at least one of the received messages. The dynamic adjusting of the priority score can increase the overall efficiency of the message processing system.

In some embodiments, performance analyzer 216 updates the message prioritization. In some embodiments, performance analyzer 216 determines an adjusted priority. The adjusted priority can be an initial priority combined with feedback weights multiplied by a feedback value. In some embodiments, the analysis includes determining the feedback value for each factor. The factors can be based on queue size, message generation rate, message processing time, load balancing, number of queues for each priority, message size, and other similar factors. In some embodiments, factors can be ranked as most important to least important. Accordingly, the feedback weights can correspond with the ranking of the factor. For example, the highest ranked factor will have the highest weighting factor.

Partitions 220 can be any combination of hardware and/or software configured to store messages to be processed. In some embodiments, partitions 220 can be separated into two or more sections. In some embodiments, the sections are a queue (e.g., queue 221 and queue 222). In some embodiments, the sections are predefined. Each section can have an assigned priority. In some embodiments, message manager 211 assigns received messages to one section of partitions 220.

In some embodiments, partitions 220 includes queue 221 and queue 222. In some embodiments, partitions 220 can include any number of additional queues, however only queue 221 and queue 222 are shown. In some embodiments, queue 221 and queue 222 are associated with a priority. There can by any number of queues assigned to any of the priorities. In some embodiments, there is at least one queue for each priority type. For example, if there are four categories, critical, high, medium, and low, there will be at least four queues. However, there can be multiple queues for any or all of the priority types.

Queue 221 can be any combination of hardware and/or software configured to store messages. In some embodiments, queue 221 can store messages received from producer 230 until the message is sent to consumer 240. In some embodiments, queue 221 can be assigned a priority type. Each message in queue 221 has the same priority.

Queue 222 can be any combination of hardware and/or software configured to store messages. In some embodiments, queue 222 can be consistent with queue 221 where the assigned priority type can be the same or different than the priority type of queue 222.

Producer 230 can be any combination of hardware and/or software configured to generate one or more messages for processing. In some embodiments, producer 230 includes a computer system, such as computer 101 of FIG. 1. In some embodiments, producer 230 is two or more separate computing devices, where each device generates messages. Producer 230 can generate a stream of messages. Each generated message can include a header with header data. The header data includes data and/or instructions related to the source, priority, destination, and/or purpose of the message. In some embodiments, producer 230 sends generated messages to message manager 211 and/or host 210.

Consumer 240 can be any combination of hardware and/or software configured to generate one or more messages for processing. In some embodiments, consumer 240 includes a computer system, such as computer 101 of FIG. 1. In some embodiments, consumer 240 is two or more separate computing devices, where each device consumer/processes messages. Consumer 240 can consume/process a stream of messages. Each message consumed can be received from message manager 211 and/or a queue from partitions 220. The assignments to consumer 240 can be configured to equalize load across the one or more of consumer 240 and/or to selectively process higher priority messages.

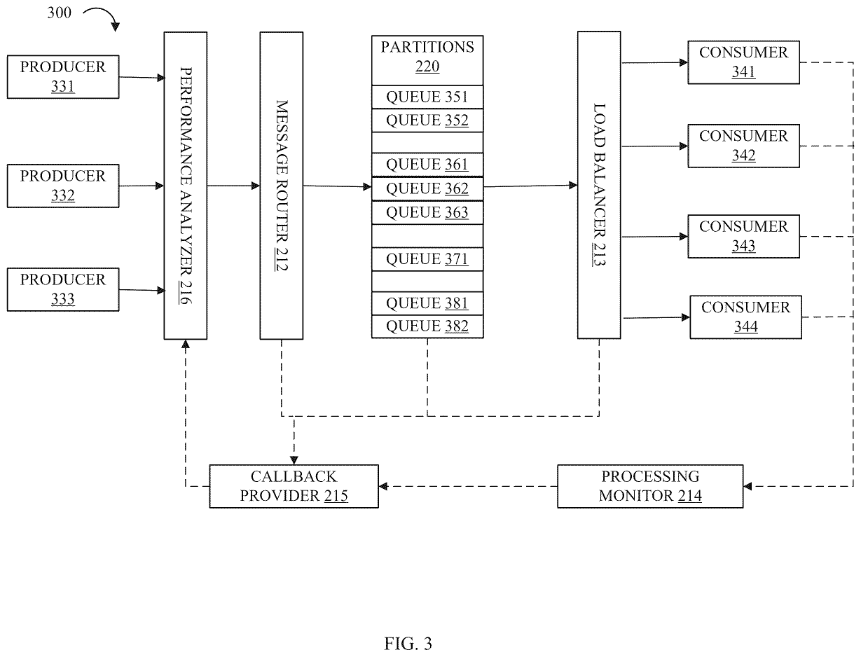

FIG. 3 includes one example embodiment of messaging system 300 configured to run message manager 211 in accordance with some embodiments of the present disclosure. FIG. 3 shows one embodiment of a data/message flow through the message system 300. The solid lines in FIG. 3 can represent message traffic and some data traffic. The dashed lines in FIG. 3 can represent data only traffic.

Message system 300 includes producer 331, producer 332, and producer 333. Each of producer 331, producer 332, and producer 333 can be consistent with producer 230 of FIG. 2. Producer 331, producer 332, and producer 333 generate messages and send them to performance analyzer 216. In some embodiments, the message pass through performance analyzer 216 to message router 212. After a time of operation, performance analyzer can dynamically update message distribution based on data and feedback received from callback provider 215. In some embodiments, performance analyzer sends updated weighting/message scoring data to message router 212.

In some embodiments, message router 212 receives the message analyzer and generates a priority score for each message. Message router 212 can calculate an initial priority and/or an adjusted priority score. The priority score can be based on a message header, source of the message, and other factors as described herein. Message router 212 sends each message to one queue in partitions 220. Message system 300 includes queue 351, queue 352, queue 361, queue 362, queue 363, queue 371, queue 381, and queue 382. Each queue can be assigned a priority level. Each priority level can have the same or different number of queues. For example, queue 351 and queue 351 can be an urgent priority, queue 361, queue 362, and queue 363 can be a high priority, queue 371 can be a medium priority, and queue 381 and queue 382 can be a low priority.

Load balancer 213 monitors the messages in partitions 220 and selectively sends them to one of consumer 341, consumer 342, consumer 343, or consumer 344. Load balancer 213 can consider various factors such as message priority, consumer load, throughput, and other similar factors. In general, load balancer 213 is configured to prioritize higher priority messages for processing and maintaining a balance between consumers according to load balancing policy and consumer specifications. Consumer 341, consumer 342, consumer 343, and consumer 344 process the messages according to the processing instruction associated with the messages.

In some embodiments, processing monitor 214 monitors various consumers as they process messages. The processing data, as well as other data from message router 212, partitions 220, and load balancer 213 is sent to callback provider 215 and/or performance analyzer 216. The data is analyzed and if the requirements are met, the routing rules and/or routing scores are dynamically updated. In various embodiments, there can be any number of producers and consumers. Additionally, there can be any number of queues associated with any priority level in partitions 220.

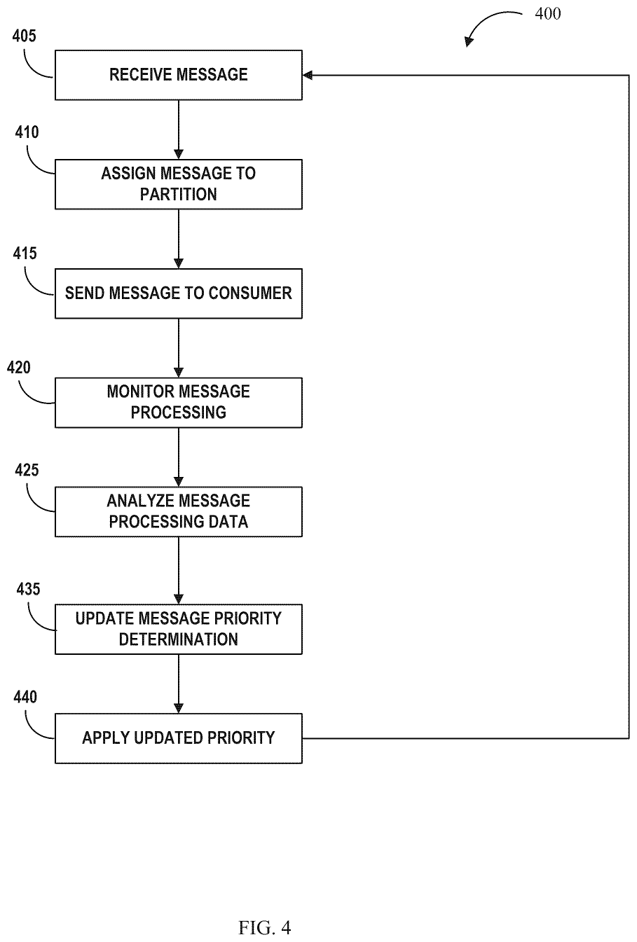

FIG. 4 is a flowchart of an example process 400 for dynamically adjusting message priority in a message queue system on a computing environment (e.g., computing environment 100 and/or computing environment 200). One or more of the advantages and improvements described above for dynamically adjusting message priority in a message system may be realized by process 400, consistent with various embodiments of the present disclosure.

Process 400 can be implemented by one or more processors, host 210, message manager 211, message router 212, load balancer 213, processing monitor 214, callback provider 215, performance analyzer 216, partitions 220, queue 221, queue 222, producer 230, consumer 240, and/or a different combination of hardware and/or software. In various embodiments, the various operations of process 400 are performed by one or more of host 210, message manager 211, message router 212, load balancer 213, processing monitor 214, callback provider 215, performance analyzer 216, partition 220, queue 221, queue 222, producer 230, consumer 240, and/or unshown components. For illustrative purposes, the process 400 will be described as being performed by message manager 211.

At operation 405, message manager 211 receives one or more messages. In some embodiments, the messages are received from producer 230. In some embodiments, the received messages are configured to be processed by consumer 240.

At operation 410, message manager 211 assigns the received message to a partition. In some embodiments, the partition is partitions 220. In some embodiments, each message is assigned to a queue of partition 220. The queue can be associated with a priority level. There can be multiple queues with a common priority level, but at least one queue for each of a predefined priority level.

In some embodiments, the assignment is based on an initial priority score. The initial priority score can be based on one or more attributes of the message. For example, when a message is generated, it may include a header with data related to the message. The initial priority score can be based on a source (e.g., producer 230, application that generated the message, user account associated with generation, etc.), a type of message, message header, a size, a destination (e.g., consumer 240), and the like. In some embodiments, the initial priority score can be based on predetermined routing rules and/or a routing policy. In some embodiments, the initial priority can be based on load balancing factors.

In some embodiments, the assignment is based on an updated priority score. An updated priority score is an initial priority score while accounting for feedback from processing monitor 214, callback provider 215, and/or performance analyzer 216. The updated priority score can be utilized on a second/subsequent iteration of process 400. In some embodiments, the updated priority score is based on operation 425, operation 435, and/or operation 440. In some embodiments, the updated is a sum of the initial priority score added to a feedback weight and a feedback value for one or more feedback factors. For example, the adjusted priority can be expressed as

$$Adjusted Priority = Initial Priority + {\sum }_{k = 0}^{n} Feedback {Weight}_{k} * Feedback {Value}_{k} ,$$

Where n is the number of feedback factors considered. The number of factors can be predetermined. Also, the number of factors can measure factors that have a non-zero result. So, at times the number of factors, n, can be different. In some embodiments, the feedback weight represents a relative effect on the priority. As the magnitude of the feedback weight increases, the magnitude of the effect on the priority increases as well. The effect can be positive or a negative effect. In some embodiments, the feedback weight can the same or different for each different factor. The feedback weights can be predetermined or dynamic. In some embodiments, the feedback value is based operation 425. The feedback value can represent identified inefficiencies in the message processing system. For example, if queues associated with one priority level are getting very full, a factor related to queue size can increase or decrease. This can result in fewer messages being directed to the over-full queues.

At operation 415, message manager 211 sends the message to a consumer. In some embodiments, the consumer is consumer 240. In some embodiments, sending is based on the assigning of operation 410. In some embodiments, the messages are sent based on a priority of the assigned partition/queue. Partitions/queues with a higher priority and send for processing before lower priority partitions. In some embodiments, the selected consumer is based on the message and/or queue priority level. For example, messages from a highest priority queue may be selectively delivered to a particular consumer. In some embodiments, the selected consumer is based on one or more load balancing factors. For example, the selected consumer can be the consumer with the appropriate bandwidth and processing power.

At operation 420, message manager 211 monitors the messages being processed. In some embodiments, the monitoring includes tracking a load and/or processing speed of the one or more consumers. The monitoring can be performed by consumer 240, load balancer 213, and/or processing monitor 214. The monitored data can be received by message manager 211 from the various monitoring components. In some embodiments, the monitoring includes tracking which messages and their associated queues/priority are processed by which consumers. Additionally, the time and/or processing resources utilized to process the messages is also monitored. In some embodiments, the monitoring includes message manager 211 receiving and storing the processing data from the various consumers.

At operation 425, message manager 211 analyzes the monitored message processing. In some embodiments, the analyzing is performed by callback provider 215 and/or performance analyzer 216. The analyzing can determine if an adjust to message router 212 and/or load balancer 213 needs adjusting. The analysis can determine if the system is out of balance. In some embodiments, the analysis identifies anomalies and/or patterns in the distribution and/or processing of messages. For example, message manager 211 can determine if one of consumer 240 is overloaded and/or underloaded. Additionally, message manager 211 can determine if any particular partition/queue and/or any priority is too large. If one queue has a large or small number of messages waiting to be processed, that can indicate the a priority is out of balance. The analysis can identify system performance, message processing times, throughput, and/or resource utilization. In some embodiments, the analyzing can recommend changes to improve the performance of the overall system. The changes can include distribution of messages to keep load balanced, and/or in the assigning the messages to the queues. message manager 211 can recommend changes to the priority scores to change the priority of at least one of the received messages. The dynamic adjusting of the priority score can increase the overall efficiency of the message processing system.

At operation 435, message manager 211 updates the message prioritization. In some embodiments, the updates can be based on analysis in operation 425. In some embodiments, operation 435 determines an adjusted priority. The adjusted priority can be an initial priority combined with feedback weights multiplied by a feedback value. In some embodiments, operation 435 includes determining the feedback value for each factor. The factors can be based on queue size, message generation rate, message processing time, load balancing, number of queues for each priority, message size, and other similar factors. In some embodiments, factors can be ranked as most important to least important. Accordingly, the feedback weights can correspond with the ranking of the factor. For example, the highest ranked factor will have the highest weighting factor.

At operation 440, message manager 211 applies the updated message prioritization. In some embodiments, operation 440 includes dynamically adjusting the assigning messages to various partitions. The adjustments are based on the updated message prioritization. In some embodiments, the updating includes applying the adjusted priority score. The applying can include pushing the updated priority to message router 212.

In some embodiments, the adjusted priority is applied if a change for a factor exceeds a change threshold. The change threshold can be an absolute or a relative (percentage) amount. For example, if a feedback value changes by 10% it can be applied. Another example, if the feedback value changes by 0.02 or more then it can exceed the threshold. The threshold can be the same or different for each factor. In some embodiments, the threshold can be applied to the feedback value alone and/or the product of the weighting factor and the feedback value. If the change threshold is not met, the process can return to operation 405 with no changes. In some embodiments, the change amount can be cumulative (e.g., from a starting point), over a period of time (e.g., every 1000 messages, period of time, etc.) and or for each cycle.

In some embodiments, message manager 211 returns to operation 405 in response to completing operation 440.

The present invention may be a system, a method, and/or a computer program product at any possible technical detail level of integration. The computer program product may include a computer readable storage medium (or media) having computer readable program instructions thereon for causing a processor to carry out aspects of the present invention.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In summary, various embodiments have been discussed which are again specified in the following numbered clauses:

Clause 1 is as follows. A computer-implemented method comprising: receiving, by a message system and from a producer, a plurality of messages; determining, based on a set of prioritization rules; a priority score for each message of the plurality of messages, where the set of prioritization rules is based on feedback from a set of messages previously processed by the message system; and sending, selectively and based on the priority, each message to a consumer for each message to be processed. Clause 1 has the technical effect of dynamically updating message prioritization based on feedback of previously processed messages. This will increase the overall efficiency of the messaging system.

Clause 2 is as follows. The computer-implemented method of clause 1 wherein the set of prioritization rules comprises an adjusted priority score, where the adjusted priority score is an initial priority score added to a product of a first factor weight and a first feedback value for a first factor. Clause 2 has the technical effect of describing how to alter the priority score.

Clause 3 is as follows. The computer-implemented method of clause 1 or 2, wherein the first feedback value is based on the feedback. Clause 3 has the technical effect of defining the relationship between the feedback and feedback value.

Clause 4 is as follows. The computer-implemented method of any of the preceding clauses further comprising: updating the set of prioritization rules from an initial prioritization rule. Clause 4 has the technical effect of explicitly stating the prioritization rules are updated.

Clause 5 is as follows. The computer-implemented method of any of the preceding clauses, wherein the updating the set of prioritization rules further comprises: for a first factor, calculating the first feedback value; and determining the product of the first factor weight and the first feedback value exceeds a change threshold, wherein the first weight factor is a predefined value. Clause 5 has the technical effect of describes how the value of the updating is determined.

Clause 6 is as follows. The computer-implemented method of any of the preceding clauses, wherein the change threshold is a number value for change. Clause 6 has the technical effect of explaining what the change threshold can be.

Clause 7 is as follows. The computer-implemented method of any clauses 1 through 5 wherein the change threshold is a percentage change value. Clause 7 has the technical effect of explaining the change threshold can be a percentage change.

Clause 8 is as follows. The computer-implemented method of any of the preceding clauses wherein; the message system includes a set of queues; the set of queues includes at least one queue for each priority in a set of priority levels; and the each message is assigned to a queue of the set of queues based on the determining the priority score. Clause 8 has the technical effect of explaining how the queues are related to the priority scores.

Clause 9 is as follows. The computer-implemented method of any of the preceding clauses, wherein the first factor is based on a size of each queue of the set of queues. Clause 9 has the technical effect of describing a relevant factor for the adjustment of the priority score.

Clause 10 is as follows. The computer-implemented method of any of the clauses 1 through 8, wherein the first factor is based on a load balance analysis of the consumer. Clause 10 has the technical effect of describing a relevant factor for the adjustment of the priority score.

Clause 11 is as follows. A system comprising: a processor; and a computer readable storage medium communicatively coupled to the processor and storing program instructions which, when executed by the processor, are configured to cause the processor to: receive, by a message system and from a producer, a plurality of messages; determine, based on a set of prioritization rules; a priority score for each message of the plurality of messages, wherein the set of prioritization rules is based on feedback from a set of messages previously processed by the message system; and send, selectively and based on the priority, each message to a consumer for each message to be processed. Clause 11 has the technical effect of dynamically updating message prioritization based on feedback of previously processed messages.

Clause 12 is as follows. The system of clause 11, wherein the set of prioritization rules comprises an adjusted priority score, where the adjusted priority score is an initial priority score added to a product of a first factor weight and a first feedback value for a first factor. Clause 12 has the technical effect of describing how to alter the priority score.

Clause 13 is as follows. The system of clause 11 or 12 wherein: the message system includes a set of queues; the set of queues includes at least one queue for each priority in a set of priority levels; and each message is assigned to a queue of the set of queues based on the determining the priority score. Clause 13 has the technical effect of linking the queues to the priority scores.

Clause 14 is as follows. The system of any of the clauses 11 through 13, wherein the program instruction are further configured to cause the processor to: for a first factor, calculate the first feedback value; determine the product of the first factor weight and the first feedback value exceeds a change threshold, wherein the first weight factor is a predefined value; and update, based on the determination that the product of first factor weight and the first feedback value exceeds a change threshold, the set of prioritization rules from an initial prioritization rule, wherein the update of the set of prioritization rules from an initial prioritization rule. Clause 14 has the technical effect of describing how the value of the updating is determined.

Clause 15 is as follows. The system of any of clauses 11 through 14 wherein the first factor is based on a size of each queue of the set of queues. Clause 15 has the technical effect of describing a relevant factor for the adjustment of the priority score.

Clause 16 is as follows. A computer program product, the computer program product comprising a computer readable storage medium having program instructions embodied therewith, the program instructions executable by a processing unit to cause the processing unit to: receive, by a message system and from a producer, a plurality of messages; determine, based on a set of prioritization rules; a priority score for each message of the plurality of messages, wherein the set of prioritization rules is based on feedback from a set of messages previously processed by the message system; and send, selectively and based on the priority, each message to a consumer for each message to be processed. Clause 16 has the technical effect of dynamically updating message prioritization based on feedback of previously processed messages. This will increase the overall efficiency of the messaging system.

Clause 17 is as follows. The computer program product of clause 16 wherein, the set of prioritization rules comprises an adjusted priority score, where the adjusted priority score is an initial priority score added to a product of a first factor weight and a first feedback value for a first factor. Clause 17 has the technical effect of describing how to alter the priority score.

Clause 18 is as follows. The computer program product of clause 16 or 17, wherein: the message system includes a set of queues; the set of queues includes at least one queue for each priority in a set of priority levels; and each message is assigned to a queue of the set of queues based on the determining the priority score. Clause 18 has the technical effect of linking the queues to the priority scores.

Clause 19 is as follows. The computer program product of any of the clauses 16 through 18, wherein the program instruction are further configured to cause the processing unit to: for a first factor, calculate the first feedback value; determine the product of the first factor weight and the first feedback value exceeds a change threshold, wherein the first weight factor is a predefined value; and update, based on the determination that the product of first factor weight and the first feedback value exceeds a change threshold, the set of prioritization rules from an initial prioritization rule, wherein the update of the set of prioritization rules from an initial prioritization rule. Clause 19 has the technical effect of describing how the value of the updating is determined.

Clause 20 is as follows. The computer program product of any of clauses 16 through 19, wherein the first factor is based on a size of each queue of the set of queues. Clause 20 has the technical effect of describing a relevant factor for the adjustment of the priority score.

What is claimed is:

1. A computer-implemented method comprising:
receiving, by a message system and from a producer, a plurality of messages;
determining, based on a set of prioritization rules; a priority score for each message of the plurality of messages, wherein the set of prioritization rules is based on feedback from a set of messages previously processed by the message system; and
sending, selectively and based on the priority, each message to a consumer for each message to be processed.

2. The computer-implemented method of claim 1, wherein the set of prioritization rules comprises an adjusted priority score, where the adjusted priority score is an initial priority score added to a product of a first factor weight and a first feedback value for a first factor.

3. The computer-implemented method of claim 2, wherein the first feedback value is based on the feedback.

4. The computer-implemented method of claim 2, further comprising:
updating the set of prioritization rules from an initial prioritization rule.

5. The computer-implemented method of claim 4, wherein the updating the set of prioritization rules further comprises:
for the first factor, calculating the first feedback value; and
determining the product of the first factor weight and the first feedback value exceeds a change threshold, wherein the first weight factor is a predefined value.

6. The computer-implemented method of claim 5, wherein the change threshold is a number value for change.

7. The computer-implemented method of claim 5, wherein the change threshold is a percentage change value.

8. The computer-implemented method of claim 2, wherein;
the message system includes a set of queues;
the set of queues includes at least one queue for each priority in a set of priority levels; and
the each message is assigned to a queue of the set of queues based on the determining the priority score.

9. The computer-implemented method of claim 8, wherein the first factor is based on a size of each queue of the set of queues.

10. The computer-implemented method of claim 2, wherein the first factor is based on a load balance analysis of the consumer.

11. A system comprising:
a processor; and
a computer readable storage medium communicatively coupled to the processor and storing program instructions which, when executed by the processor, are configured to cause the processor to:
receive, by a message system and from a producer, a plurality of messages;
determine, based on a set of prioritization rules; a priority score for each message of the plurality of messages, wherein the set of prioritization rules is based on feedback from a set of messages previously processed by the message system; and
send, selectively and based on the priority, each message to a consumer for each message to be processed.

12. The system of claim 11, wherein the set of prioritization rules comprises an adjusted priority score, where the adjusted priority score is an initial priority score added to a product of a first factor weight and a first feedback value for a first factor.

13. The system of claim 12, wherein:
the message system includes a set of queues;
the set of queues includes at least one queue for each priority in a set of priority levels; and
each message is assigned to a queue of the set of queues based on the determining the priority score.

14. The system of claim 13, wherein the program instructions are further configured to cause the processor to:
for the first factor, calculate the first feedback value;
determine that the product of the first factor weight and the first feedback value exceeds a change threshold, wherein the first weight factor is a predefined value; and
update, based on the determination that the product of the first factor weight and the first feedback value exceeds a change threshold, the set of prioritization rules from an initial prioritization rule.

15. The system of claim 14, wherein the first factor is based on a size of each queue of the set of queues.

16. A computer program product, the computer program product comprising a computer readable storage medium having program instructions embodied therewith, the program instructions executable by a processing unit to cause the processing unit to:
receive, by a message system and from a producer, a plurality of messages;
determine, based on a set of prioritization rules; a priority score for each message of the plurality of messages, wherein the set of prioritization rules is based on feedback from a set of messages previously processed by the message system; and
send, selectively and based on the priority, each message to a consumer for each message to be processed.

17. The computer program product of claim 16, the set of prioritization rules comprises an adjusted priority score, where the adjusted priority score is an initial priority score added to a product of a first factor weight and a first feedback value for a first factor.

18. The computer program product of claim 17, wherein:
the message system includes a set of queues;
the set of queues includes at least one queue for each priority in a set of priority levels; and
each message is assigned to a queue of the set of queues based on the determining the priority score.

19. The computer program product of claim 18, wherein the program instructions are further configured to cause the processing unit to:
for the first factor, calculate the first feedback value;
determine the product of the first factor weight and the first feedback value exceeds a change threshold, wherein the first weight factor is a predefined value; and
update, based on the determination that the product of the first factor weight and the first feedback value exceeds a change threshold, the set of prioritization rules from an initial prioritization rule.

20. The computer program product of claim 19, wherein the first factor is based on a size of each queue of the set of queues.
